(19) United States
(12) Patent Application Publication
(10) Pub. No.: US 2008/0007150 A1
(43) Pub. Date: Jan. 10, 2008

(54) Plasma tube array

(75) Inventors: Yosuke Yamazaki, Kobe (JP); Akira Tokai, Kawasaki (JP); Kenji Awamoto, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CORPORATION, Kobe (JP)

(21) Appl. No.: 11/898,371

(22) Filed: Sep. 11, 2007

Related U.S. Application Data
(63) Continuation of application No. PCT/JP05/04297, filed on Mar. 11, 2005.

(51) Int. Cl. H01J 63/04

(52) U.S. Cl. 313/485

(57) ABSTRACT

A plasma tube array in which a number of arc each including a phosphor layer inside are arranged. The plasma tube array displays an image by causing discharge inside the arc tubes so that the phosphor layers inside the arc tubes are allowed to emit light. This plasma tube array has a structure with which phosphor layers can be easily aligned in a predetermined direction. The plasma tube array includes alignment members, each of which is disposed at one end of a corresponding one of the arc tubes, and which regulate the postures in a rotational direction of the respective arc tubes.

### CROSS REFERENCE TO RELATED APPLICATION

This application is a continuing application, filed under 35 U.S.C. §111(a), of International Application PCT/JP2005/004297, filed Mar. 11, 2005, the contents of which are incorporated herein by reference.

### TECHNICAL FIELD

The present invention relates to a plasma tube array, in which arc tubes each having a phosphor layer inside are arranged, and which displays an image by causing discharge inside the arc tubes, and thereby allowing the phosphor layers inside the arc tubes to emit light.

### BACKGROUND ART

As a large self-luminous image display device, a technique has been proposed, which applies the principle of a plasma display. Specifically, luminous yarns are arranged. Each luminous yarn is formed of a glass tube which has a phosphor layer and the like inside, and which is used for displaying an image by controlling light emission in each portion of each of the luminous yarns (see Patent Document 1).

In each of the luminous yarns, an MgO layer and the phosphor layer are formed inside the glass tube, and discharge gas made of, for example, Ne and Xe is enclosed in the glass tube. The phosphor layer is formed on a supporting member called a boat, which is a mounting component having a substantially semicircular cross-sectional shape. The supporting member (boat) is then inserted into the glass tube. Thereafter, the glass tube is heated and evacuated in a vacuum chamber. After the glass tube is filled with the discharge gas, both ends of the glass tube are melted to be sealed. The luminous yarns each fabricated in this manner are arranged and fixed, in parallel, and in a direction that maximizes a projected area of an opening of each boat. Moreover, electrodes are provided on atop and a bottom of each of the luminous yarns, respectively. By applying a voltage to the electrodes, discharge is caused inside the luminous yarns, and thereby the phosphor is allowed to emit light.

FIG. 1 is a perspective view showing a basic structure of a plasma tube array.

A plasma tube array (PTA) 100 shown in FIG. 1 has the following structure. Specifically, a large number of luminous yarns 10R, 10G, 10B, 10R, 10G, 10B, . . . are arranged in parallel with one another, and in a planar shape as a whole. In each luminous yarn, a phosphor layer is disposed, and discharge gas is enclosed. Each of the phosphor layers 10R, 10G, 10B, 10R, 10G, 10B, . . . , emits fluorescence of a corresponding one of red (R), green (G) and blue (B). On front and back sides of the luminous yarns 10R, 10G, 10B, 10R, 10G, 10B, . . . thus arranged, transparent front and back supporting substrates 20 and 30 are disposed, respectively. The arranged luminous yarns 10R, 10G, 10B, 10R, 10G, 10B, . . . , have a structure in which the luminous yarns are sandwiched between the front and back supporting substrates 20 and 30.

Moreover, on the front supporting substrate 20, display electrode pairs 21 are formed in a direction in which the luminous yarns 10R, 10G, 10B, 10R, 10G, 10B, . . . , are arranged. In other words, the display electrode pairs 21 are formed across the luminous yarns 10R, 10G, 10B, 10R, 10G, 10B, . . . . Each electrode pair 21 includes two display electrodes 211 and 212 extending parallel to each other. A number of the display electrode pairs 21 are arranged in the lengthwise direction of the luminous yarns 10R, 10G, 10B, 10R, 10G, 10B, . . . . . Moreover, each two display electrodes 211 and 212 included in each display electrode pair 21 are formed of bus electrodes 211a and 212a, and transparent electrodes 211b and 212b. The bus electrodes 211a and 212a are made of metal (for example, Cr/Cu/Cr), and are formed respectively at sides far away from each other. In addition, the transparent electrodes 211b and 212b are formed of ITO thin films, and are formed respectively at sides adjacent to each other. The bus electrodes 211a and 212a are used for reducing electric resistance of the corresponding display electrodes 211 and 212, and the transparent electrodes 211b and 212b are designed to achieve bright display by allowing light emitted by the luminous yarns 10R, 10G, 10B, 10R, 10G, 10B, . . . to transmit towards the front supporting substrate 20 without shielding the light. Here, each of the display electrode pairs 21 may be formed of an electrode having a structure with a high aperture ratio, such as a mesh electrode, instead of the transparent electrode.

Moreover, on the back supporting substrate 30, a number of signal electrodes 31 are formed so as to correspond to the arranged luminous yarns 10R, 10G, 10B, 10R, 10G, 10B, . . . respectively. The signal electrodes 31 are made of metal, and extend parallel to each other along the respective luminous yarns.

When the PTA 100 configured in this manner is viewed from directly above, each of the intersections of the signal electrodes 31 and the display electrode pairs 21 serves as a unit light emission region (a unit discharge region). Display is performed in the following manner. Specifically, one of the display electrodes 211 and 212 is used as a scanning electrode, and an emission region is selected by causing selective discharge in the intersection of the scanning electrode and the signal electrode 31. Wall charge is formed on the inner surface of the luminous yarn in the region in association with the discharge. Then, by utilizing the wall charge, display discharge is caused between the display electrodes 211 and 212, and thereby display is performed. The selective discharge is counter discharge caused inside the luminous yarn between the scanning electrode and the signal electrode 31 which face each other in the up-and-down direction. Meanwhile, the display discharge is surface discharge caused inside the luminous yarn between the display electrodes 211 and 212 which are disposed in parallel on a plane. Such an arrangement of the electrodes allows formation of a number of light emission regions inside each of the luminous yarns in the lengthwise direction of the luminous yarns.

Here, in the electrode structure shown in FIG. 1, three electrodes are disposed in one light emission region, and the display discharge is caused by the display electrodes 211 and 212. However, the present invention is not limited to the structure, but may be applicable to a structure in which the display discharge is caused between the signal electrode 31 and the display electrodes 211 and 212. Specifically, the present invention may be applicable to the following electrode structure. Each pair of the display electrodes 211 and 212 is replaced with one display electrode. By using this one display electrode as the scanning electrode, the selective discharge and the display discharge (counter discharge) are caused between the scanning electrode and a data electrode 3.

FIG. 2 is a schematic view showing a structure of the luminous yarns included in the PTA 100 shown in FIG. 1.

Here, FIG. 2 shows three luminous yarns 10R, 10G and 10B. Each of the luminous yarns 10R, 10G and 10B has the following structure. Specifically, a protective film 12 such as MgO is formed on the inner surface of a glass tube 11. Moreover, a boat 13 as a supporting member is inserted into each of the glass tube 11. In the boat 13, a corresponding one of phosphor layers 14R, 14G and 14B which emit fluorescence of the respective colors R, G and B, is formed (see Patent Document 2).

FIG. 3 is a view showing the boat in which the phosphor layer is formed.

The boat 13 has a semicircular shape, a U-shape or shapes approximate to those shapes, and also has an elongated shape similar to the glass tube 11 (see FIG. 2). Inside the boat 13, a corresponding one of the three kinds of phosphor layers 14R, 14G and 14B (see FIG. 2: here, represented by the phosphor layer 14) is formed. The phosphor layers 14R, 14G and 14B correspond respectively to the three kinds of luminous yarns 10R, 10G and 10B shown in FIGS. 1 and 2.

The description will be continued with reference to FIG. 2 again.

Each of the luminous yarns 10R, 10G and 10B shown in FIG. 2 is formed by inserting the boat 13 having the shape shown in FIG. 3 into the glass tube 11. FIG. 2 shows that the display electrode pair 21 including two display electrodes 211 and 212 is disposed on the luminous yarns 10R, 10G and 10B. Each of the two display electrodes 211 and 212 is formed of the corresponding one of the bus electrodes 211a and 212a made of metal and the corresponding one of the transparent electrodes 211b and 212b.

Here, in the case of the structure shown in FIG. 2, the three luminous yarns 10R, 10G and 10B including the three kinds of phosphor layers 14R, 14G and 14B, respectively, are grouped into one set. Moreover, a region D1 defined by one display electrode pair 21 including two display electrodes 211 and 212 is set to be one pixel that is a unit of color image display. A diameter of each of the luminous yarns 10R, 10G and 10B is typically about 1 mm. Accordingly, in the case of the structure shown in FIG. 2, a size of the region Dl for one pixel is 3 mm×3 mm.
Patent Document 1: Japanese Unexamined Patent Application Publication No. S61-103187
Patent Document 2: Japanese Patent Application Laid-open Publication No. 2003-86141

### DISCLOSURE OF THE INVENTION

### Problems to be Solved by the Invention

FIG. 4 is a view for explaining problems. Here, each of Part (A) and Part (B) of FIG. 4 shows two luminous yarns 10.

A boat 13 is inserted into each of the luminous yarns 10, and has a phosphor layer mounted thereon. The boat 13 has a semicircular cross-section, a U-shaped cross-section or a cross-section of a shape approximate thereto. On the other hand, a glass tube 11 forms each of the luminous yarns 10, and has a circular cross-section, an elliptical cross-section or a cross-section having a shape approximate thereto. For this reason, the boats 13 which should ideally have the maximum projected area towards an image display surface (the front supporting member 20 side) as shown in FIG. 4 can be disposed while being shifted to the left or right as shown in Part (B) of FIG. 4. In an extreme case, the boat may possibly be turned upside down.

For this reason, even if the luminous yarns each having an even emission property are aligned, apparent brightness varies among the luminous yarns when the alignment is inaccurate. This leads to a problem that unevenness occurs in array display.

Moreover, as another problem, since a phosphor layer 14 in a non-light-emission state is white regardless of its emission color, it becomes difficult to discriminate among kinds of phosphor layers when the phosphor layers are arrayed. As a result, a problem occurs, particularly, in the case of correcting a trouble.

In consideration of the foregoing circumstances, an object of the present invention is to provide a plasma tube array having a structure that facilitates the alignment of phosphor layers in a predetermined direction.

### Means for Solving the Problem

A plasma tube array of the present invention for achieving the foregoing object is characterized by including: a number of arc tubes, each of which includes a phosphor layer inside, and which are arranged parallel to one another in a plane; front and back supporting substrates which hold the arc tubes therebetween; a number of display electrode pairs, which are arranged parallel to one another across the arc tubes on the front supporting substrate, each of which display electrode pairs includes two display electrodes extending parallel to each other; a number of signal electrodes, which extend parallel to each other along the arc tubes so as to correspond to the respective arc tubes on the back supporting substrate. In the plasma tube array, by applying a voltage to the signal electrodes and the display electrode pairs, discharge is caused inside the arc tubes so that phosphor inside the arc tubes is allowed to emit light. The plasma tube array is also characterized by including alignment members, each of which is disposed at one end of a corresponding one of the arc tubes, and which regulate the postures in a rotational direction of the respective arc tubes.

Since the plasma tube array of the present invention includes the alignment members, the rotational postures of the arc tubes are regulated by the alignment members. Accordingly, the arc tubes can be arranged while aligning the phosphor layers in a predetermined direction.

Here, in the plasma tube array of the present invention, it is preferable that the plasma tube array include supporting members, each of which has a phosphor layer formed thereon, and which are inserted respectively in the arc tube, and that the alignment members be integrated respectively with the supporting members.

Alternatively, in the plasma tube array of the present invention, it is also preferable that the plasma tube array include sealing members each of which seals one end of a corresponding one of the arc tubes, and that the alignment members be integrated respectively with the sealing members.

Moreover, in the plasma tube array of the present invention, it is also preferable that the alignment members have different shapes, which depend on the respective kinds of the arc tubes, and which engage only with the alignment members provided at one ends of the arc tubes of the kinds allowed to be adjacent. Furthermore, it is also preferable that the plasma tube array includes a positioning member, which engage with the alignment members, and which aligns the arc tubes.

### Effects of the Invention

According to the present invention, a structure with which phosphor layers can be easily aligned in a predetermined direction.

### BRIEF DESCRIPTION OF THE DRAWINGS

FIG. 1 is a perspective view showing a basic structure of a plasma tube array.

FIG. 2 is a schematic view showing a structure of luminous yarns included in the PTA shown in FIG. 1.

FIG. 3 is a view showing a boat in which a phosphor layer is formed.

FIG. 4 is a view for explaining problems.

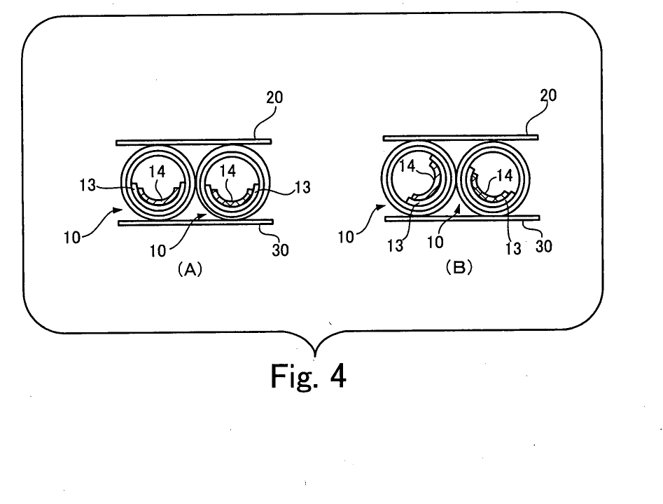

FIG. 5 is a perspective view showing an alignment structure of luminous yarns in a plasma tube array according to a first embodiment that is a basic embodiment of the present invention.

FIG. 6 is a side view seen from an end face side of the luminous yarn, showing the alignment structure of luminous yarns in the plasma tube array according to the first embodiment that is the basic embodiment of the present invention.

FIG. 7 is a perspective view showing an alignment structure of luminous yarns in a plasma tube array according to a second embodiment of the present invention.

FIG. 8 is a view showing a modified example of the second embodiment shown in FIG. 7.

FIG. 9 is a perspective view showing an alignment structure of luminous yarns in a plasma tube array according to a third embodiment of the present invention.

FIG. 10 is a side view showing an alignment structure of luminous yarns in a plasma tube array according to a fourth embodiment of the present invention.

FIG. 11 is an explanatory view showing an example of a method of aligning luminous yarns in a plasma tube array according to one embodiment of the present invention.

FIG. 12 is a view showing a modified example of an alignment member.

### BEST MODE FOR CARRYING OUT THE INVENTION

Various embodiments of the present invention will be described below.

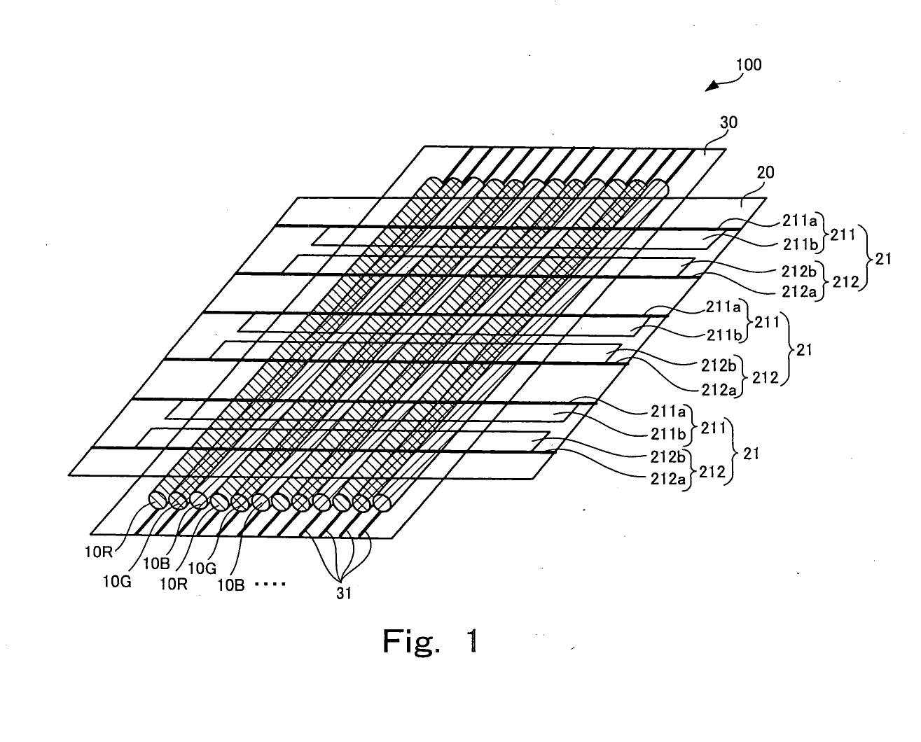

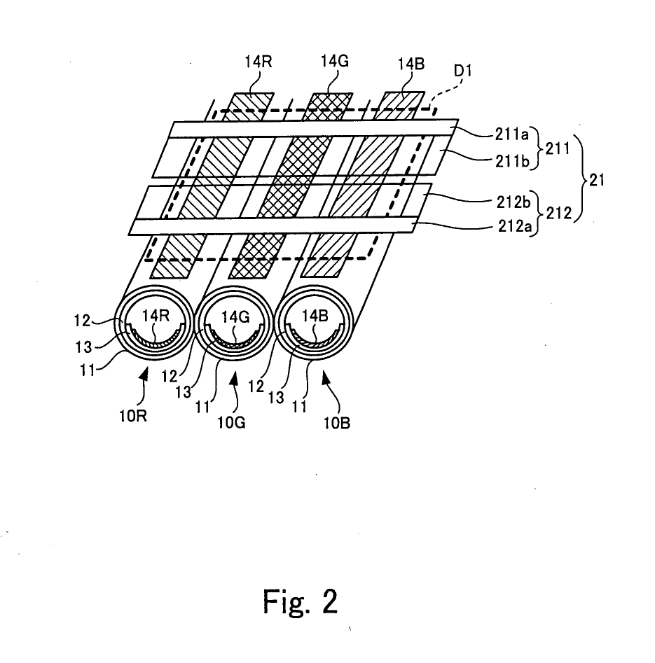

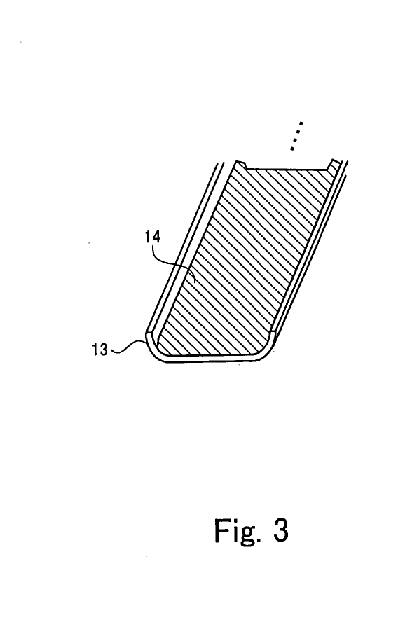

Each of the embodiments to be described below is obtained by adding a structure for aligning luminous yarns by setting phosphor layers on boats in a predetermined direction to the conventional technique (FIGS. 1 to 3) described above. Therefore, FIGS. 1 to 3 are to be referred to for the entire structure also in each of the embodiments to be described below. Here, features in the respective embodiments will be mainly described.

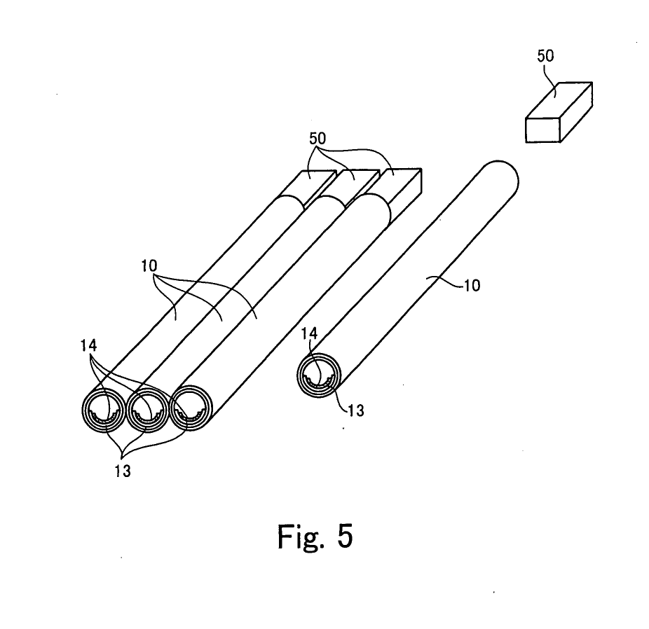

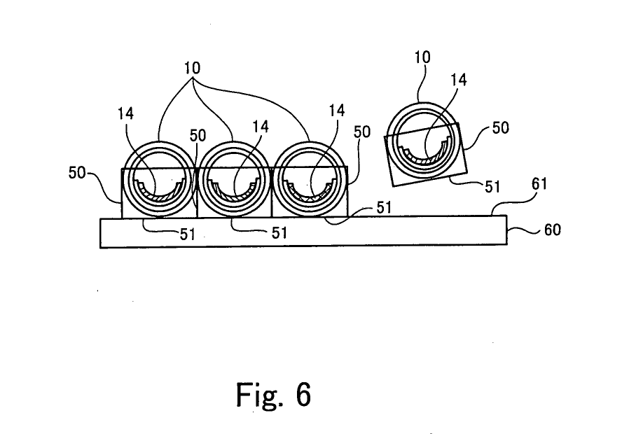

FIGS. 5 and 6 are a perspective view and a side view seen from an end face side of the luminous yarns, respectively, showing an alignment structure of luminous yarns in a plasma tube array according to a first embodiment that is a basic embodiment of the present invention.

An alignment member 50 is fixed to one end of each of luminous yarns 10. Accordingly, when the luminous yarns 10 are aligned, boats 13, which are disposed inside the respective luminous yarns 10, and which have phosphor layers 14 formed thereon, can be aligned in a predetermined direction. The alignment members 50 can be fixed simultaneously when the boats 13 are inserted respectively into the luminous yarns 10. Moreover, the alignment members 50 can be fixed while being accurately aligned with the direction of the boats 13.

Each of the alignment members 50 has a flat surface 51 at its bottom as shown in FIG. 6. When the luminous yarns 10 are aligned, alignment for setting the boats 13 of the respective luminous yarns 10 in the optimum direction can be performed by placing the alignment members 50 fixed to the respective luminous yarns 10 on a flat plate 60 having a flat surface 61. Moreover, in this embodiment, each of the alignment members 50 is fixed at a position close to a lower side of the corresponding luminous yarn 10. Accordingly, the luminous yarn 10 is also prevented from being set in an inverted state.

Note that, in the first embodiment shown in FIGS. 5 and 6, the description was given of the case where the luminous yarns 10 are disposed on the flat plate 60. The flat plate 60 may be a curved plate having a curved surface. In this case, the flat surface 51 is formed of a curved surface that follows the curved surface of the curved plate.

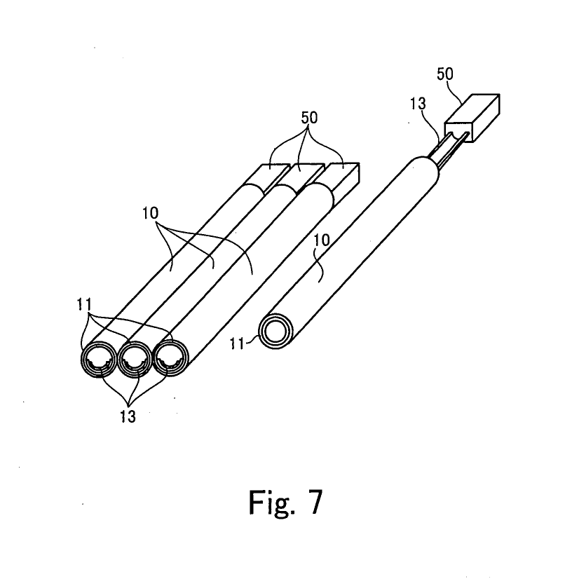

FIG. 7 is a perspective view showing an alignment structure of luminous yarns in a plasma tube array according to a second embodiment of the present invention. Description will be given of differences from the first embodiment shown in FIGS. 5 and 6.

In the case of the second embodiment shown in FIG. 7, the alignment members 50 are fixed respectively to the boats 13 in advance, and the boats 13 each having the alignment member 50 fixed thereto are inserted respectively into glass tubes 11. Accordingly, it is not required to align the alignment members 50 when the boats 13 are inserted respectively into the glass tubes 11. As a result, more accurate alignment can be more easily performed.

In fabrication of the luminous yarns 10 shown in FIG. 7, the boats 13 made of glass and the alignment members 50 made of glass are mounted on an alignment jig and are fixed by laser welding. Each of the boats is mounted on a groove portion of the jig while keeping a U-shaped opening of the boat upward, and is fixed so as to come into contact with an alignment part provided in a rectangular hole at an end of the jig. After the alignment part is fixed, a phosphor layer is formed. The boat 13 is inserted into the glass tube 11, which has a diameter of 1 mm (a wall thickness of 0.1 mm) and an overall length of 100 cm, and in which an MgO film has been already formed. An end of the glass tube 11, on the side where the alignment member 50 is fixed thereto, is fixed by welding. The glass tube 11 is put into an exhaust chamber, and is then depressurized to vacuum. Thereafter, the glass tube 11 is filled with discharge gas and the opposite end of the glass tube 11 is sealed.

The luminous yarns 10 thus completed are aligned on a flat plate (see FIG. 6). Each of the alignment members 50 has a width that does not interfere with the adjacent alignment members 50 on both sides thereof. Moreover, by placing a flat surface 51 of the alignment member 50 on the flat plate, automatic positioning in a direction in which the glass tube 11 rotates can be performed. By holding the luminous yarns 10 aligned in this manner by the top and bottom with a front supporting member 20 having display electrode pairs 21 formed thereon and a back supporting member 30 having signal electrodes 31 formed thereon (see FIG. 1), a plasma tube array is formed.

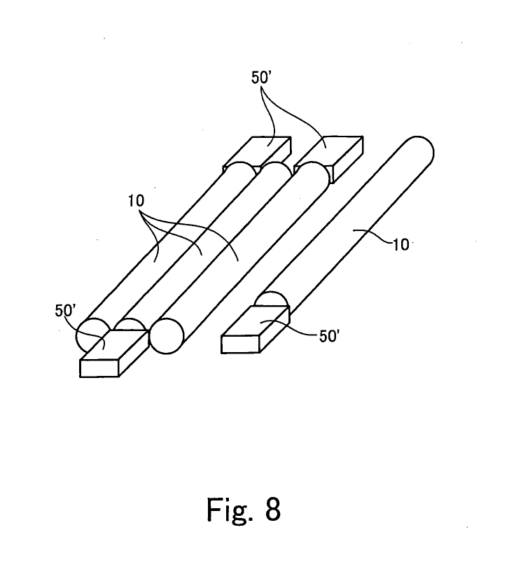

FIG. 8 is a view showing a modified example of the second embodiment shown in FIG. 7.

While each of the alignment members 50 shown in FIG. 7 has the width that does not exceed the diameter of the luminous yarn 10, each of alignment members 50′ is formed so as to have a width larger than the diameter of the luminous yarn 10. In the case of the modified example shown in FIG. 8, each of the alignment members 50′ is formed so as to have a large width, and the alignment members 50′ are arranged alternately at ends opposite to each other. In other words, the alignment members 50′ are arranged while alternately changing directions of the respective alignment members 50′. Accordingly, since the width of each of the alignment members 50′ is large, the direction of the luminous yarn 10 can be stabled. As a result, more highly accurate arrangement can be achieved.

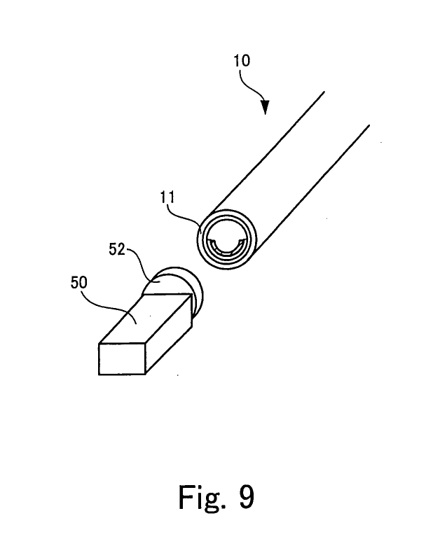

FIG. 9 is a perspective view showing an alignment structure of luminous yarns in a plasma tube array according to a third embodiment of the present invention. Description will be given of differences from the first embodiment shown in FIGS. 5 and 6.

In the case of the third embodiment shown in FIG. 9, an alignment member 50 is integrated with a sealing member 52 for sealing a glass tube 11. In order to complete the glass tube as a luminous yarn 10, it is required to close tube ends of the glass tube 11 after filling the glass tube 11 with gas. Generally, the tube ends are closed by fusion sealing with heat or by cover sealing using a pellet. By providing the alignment member 50 with a function as the sealing member 52 equivalent to the pellet, work efficiency can be improved.

A cross-section of the alignment member 50 in a portion of the sealing member 52, which comes into contact with the tube end of the glass tube 11, is larger than the cross section of the glass tube 11. Accordingly, the tube end of the glass tube 11 can be completely covered with the sealing member. Here, after the boat 13 is inserted, the sealing member 52 included in the alignment member 50 is pressure-bonded to the glass tube 11 by applying glass paste to a contact area therebetween. After the pressure bonding, only the tube end portion is heated by a heater to achieve airtightness.

Note that the end face of the alignment member 50 on the glass tube 11 side is not necessarily flat. The airtightness in sealing can be further improved by allowing the end face to have a shape that is partially inserted into the glass tube.

Moreover, the alignment member 50 may be integrated with the boat 13 as shown in FIG. 7, and maybe further provided with the sealing function as shown in FIG. 8. Accordingly, higher accuracy and simplification of alignment can be achieved at the same time. Furthermore, discrimination may be facilitated by partially changing the shape of the alignment member 50 in accordance with the color of light emitted from phosphor sealed in the luminous yarn.

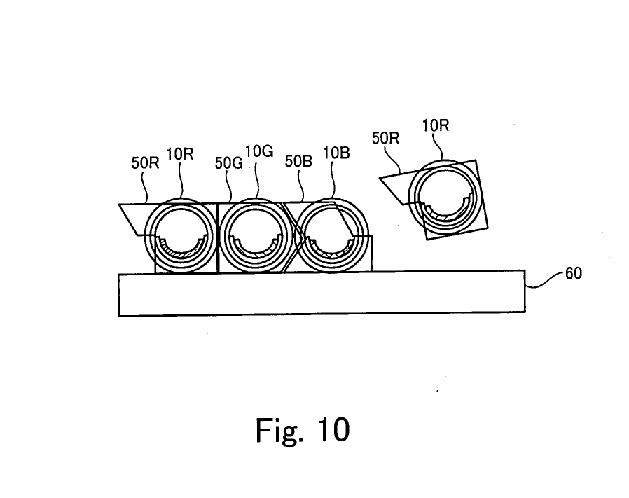

FIG. 10 is a side view showing an alignment structure of luminous yarns in a plasma tube array according to a fourth embodiment of the present invention.

Here, alignment members 50R, 50G and 50B having different shapes from one another depending respectively on kinds of luminous yarns 10R, 10G and 10B are fixed to tube ends of the respective luminous yarns 10R, 10G, 10B, . . . in which phosphor layers 14R, 14G, 14B, . . . with respective emission colors, red (R), green (G) and blue (B) are sealed. The alignment members 50R, 50G and 50B have shapes which engage one another only in the case where the luminous yarns 10R, 10G and 10B filled with kinds of phosphors to be positioned side by side are arranged side by side when the luminous yarns 10R, 10G, 10B, . . . are aligned on the flat plate 60. Accordingly, when the luminous yarns 10R, 10G and 10B are aligned, the luminous yarns 10R, 10G and 10B can be arranged in the correct order without paying particular attention, at the same time as positioning of the luminous yarns 10R, 10G and 10B in a rotation direction of each of the luminous yarns 10R, 10G and 10B.

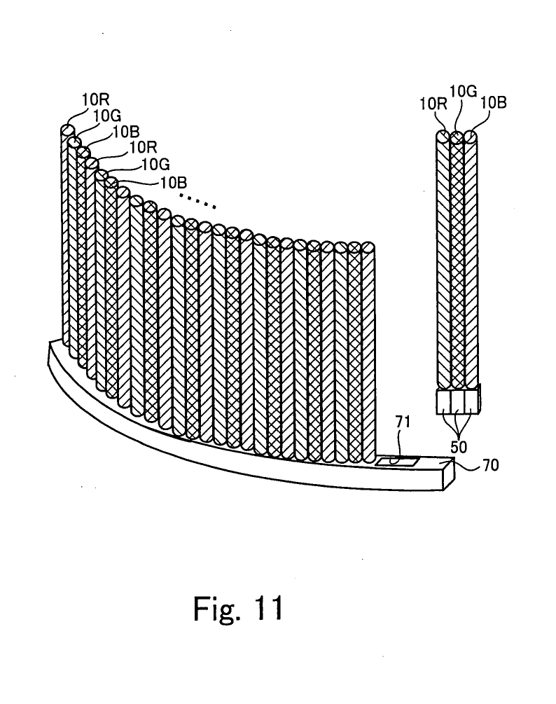

FIG. 11 is an explanatory view showing an example of a method of aligning luminous yarns in a plasma tube array according to one embodiment of the present invention.

A method of fabricating luminous yarns 10R, 10G, 10B, . . . themselves shown in FIG. 11 is the same as that described above. Meanwhile, here, the luminous yarns 10R, 10G, 10B, . . . are positioned by inserting alignment members 50 into positioning grooves 71 of a positioning member 70. Each of the positioning grooves 71 corresponds to the shape of a corresponding one of the alignment members 50 fixed to the luminous yarns 10R, 10G, 10B, . . . . Here, three kinds of luminous yarns 10R, 10G and 10B, one for each color, are set as a unit and temporarily fixed on a flat plate jig. In this event, the alignment members 50 are also used so as not to cause a shift in positions of phosphors inside the three luminous yarns 10R, 10G and 10B. When there is a problem regarding strength since the luminous yarns 10R, 10G and 10B are long, temporary fixation spots may be provided also on the opposite ends, or on the back surfaces. After the temporary fixation, a back supporting member 30 (see FIG. 1) having signal electrodes 31 disposed thereon is fixed onto the back.

The set of three luminous yarns thus fabricated is inserted into the positioning groove 71 for alignment, which is provided in the curved positioning member 70.

The long side of the positioning groove 71 is set parallel to a tangent line of the positioning member 70 in a portion corresponding to the midpoint of the positioning groove 71.

After the luminous yarns are bonded and fixed respectively to the positioning groove 71, a reinforcement backing plate is fixed from behind, and a front supporting member 20 (see FIG. 1) having display electrode pairs arranged thereon is fixed to the front.

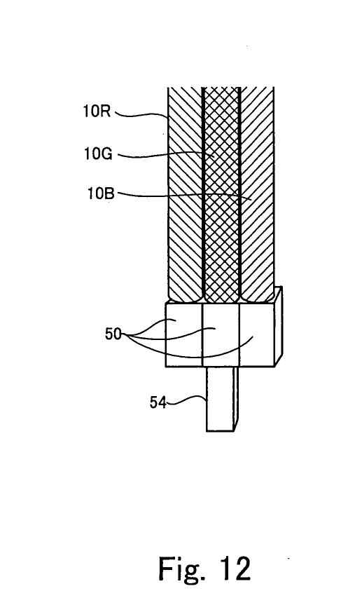

FIG. 12 is a view showing a modified example of the alignment member.

Alignment members 54 to be inserted respectively into the positioning grooves 71 are not necessarily the alignment members 50 of the three luminous yarns 10R, 10G and 10B. As shown in FIG. 12, for the three luminous yarns 10R, 10G and 10B, one small alignment member may be provided.

Note that, as a matter of course, it is also possible to adopt a structure in which the luminous yarns 10R, 10G and 10B are independently inserted into the positioning grooves 71 one by one.

As described above, according to the embodiments of the present invention, a variation in brightness of the plasma tube array as a whole, which is caused by a shift of the luminous yarns in the rotation direction of the luminous yarns, can be reduced. Accordingly, striped shades on the plasma tube array, which have heretofore been seen as a problem caused by the variation in brightness, can be removed. Since the structure of the present invention is very simple, material costs are hardly increased. Moreover, since fixing of the boats to the alignment parts is easily automated, there is not much increase in the number of steps. On the contrary, angling which has heretofore been performed while relying on an operator's eyes is no longer required. As a result, steps for assembling the plasma tube array are significantly simplified. Accordingly, the number of steps as a whole is significantly reduced.

As described above, application of the present invention enables improvement in alignment accuracy for the luminous yarns while reducing the overall costs in assembly of plasma tube array.

1. A plasma tube array comprising:
a plurality of arc tubes, each of which includes a phosphor layer inside, and which are arranged parallel to one another;
front and back supporting substrates, which hold the plurality of arc tubes therebetween;
a plurality of display electrodes, which are formed across the plurality of arc tubes on a surface of the front supporting substrate, the surface facing the plurality of arc tubes;
a plurality of signal electrodes, which are formed along the plurality of arc tubes so as to correspond to the respective arc tubes, on a surface of the back supporting substrate, the surface facing the plurality of arc tubes; and
alignment members, each of which is disposed at one end of a corresponding one of the plurality of arc tubes, and which regulate the postures in a rotational direction of the respective arc tubes.

2. The plasma tube array according to claim 1, further comprising supporting members, each of which has a phosphor layer formed thereon, and which are inserted respectively in the arc tubes,
wherein the alignment members are integrated respectively with the supporting members.

3. The plasma tube array according to claim 1, further comprising sealing members, each of which seals the one end of a corresponding one of the arc tubes,
wherein the alignment members are integrated respectively with the sealing members.

4. The plasma tube array according to claim 1,
wherein the alignment members have different shapes, which depend on the respective kinds of the arc tubes, and which engage only with the alignment members provided at one ends of the arc tubes of the kinds allowed to be adjacent.

5. The plasma tube array according to claim 1, further comprising:
a positioning member, which engages with the alignment members, and which aligns the plurality of arc tubes.
